(19) United States
(12) Patent Application Publication
(10) Pub. No.: US 2023/0248045 A1
(43) Pub. Date: Aug. 10, 2023

(54) FRUIT CLAMPING TOOL, IN PARTICULAR FOR CLAMPING PEACHES, MACHINE AND METHOD FOR PITTING FRUIT WITH SUCH A TOOL

(71) Applicant: Biagio CRESCENZO, Salerno (IT)

(72) Inventor: Biagio CRESCENZO, Salerno (IT)

(21) Appl. No.: 18/103,965

(22) Filed: Jan. 31, 2023

(30) Foreign Application Priority Data
Feb. 4, 2022 (IT) 102022000001979

(51) Int. Cl. A23N 4/04; A23N 4/22

(52) U.S. Cl. CPC A23N 4/04; A23N 4/22

(57) ABSTRACT

A clamping tool for clamping a fruit, in particular a peach, in a given position in a processing station of a pitting machine has a tubular shape, extends around a given axis and is provided with a first opening configured to allow the clamping tool to be arranged over and around the fruit; a second opening arranged on the opposite side relative to the first opening to allow for the insertion of cutting tools inside the clamping tool in a direction parallel to said axis; two through channels, which are parallel to said axis and extend from the first to the second opening; and two walls facing each other, separated by the channels and converging towards the axis between the first and the second opening.

### CROSS-REFERENCE TO RELATED APPLICATIONS

This patent application claims priority from Italian Patent Application No. 102022000001979 filed on Feb. 4, 2022. The entire disclosure of the aforementioned priority application is incorporated herein by reference in its entirety.

### TECHNICAL FIELD

The invention relates to a clamping tool for clamping a fruit during pitting operations.

### BACKGROUND

A clamping tool for clamping a fruit, in particular a peach, in a given position relative to a pitting knife is disclosed in patent EP 3,419,441 B 1. The pitting of fruit such as peaches also entails dividing the peaches into two halves with suitable blades. The clamping tool described in the aforesaid patent extends around a given axis and is provided with a first opening designed to allow the clamping tool to be arranged around the upper portion of a fruit; a second opening, on the opposite side relative to the first opening, designed to allow a pitting knife to be introduced into the clamping tool in a direction parallel to said axis; and an annular wall converging towards said axis between the first and the second opening so as to adhere to the fruit. The annular wall is selectively deformable through the selective feeding of compressible fluid into an annular chamber adjacent to the wall so as to clamp the annular wall around the fruit and prevent the fruit from rotating during the rotation of the pitting knife.

Even though this clamping tool has proved to be particularly reliable, it is not completely suited to allow other processing operations to be carried out simultaneously with and/or immediately after the activation of the pitting knife.

### SUMMARY

The invention provides a clamping tool for clamping a fruit, in particular a peach, in a given position in a processing station of a pitting machine, the clamping tool having a tubular shape and extending around a given axis and being provided with: a first opening configured to allow the clamping tool to be arranged over and around the fruit; a second opening, which is smaller than the first opening and is arranged on the opposite side relative to the first opening, to allow the cutting tools to be inserted into the clamping tool in a direction parallel to said axis; two through channels substantially parallel to said axis extending from the first opening to the second opening; and two walls facing each other and separated by said channels and converging towards said axis between the first and the second opening.

In this way, the clamping tool allows the fruit to be held by means of the walls and prevents it from rotating when the pitting knife is rotated inside the fruit, at the same time offering space for accommodating, on the inside, both the blades needed to cut the fruit and the pitting knife. Indeed, the blades can at least partly be rotated in the channels of the clamping tool and allow for the insertion of the pitting knife. As a consequence, the clamping tool according to the invention allows the cutting of the fruit and the separation of the pulp from the stone to be carried out in one single processing station. In particular, said walls are made of a deformable material, in particular rubber, so that the grip can be adjusted to the shape and the size of the fruit.

According to an embodiment of the invention, the clamping tool comprises a tubular body configured to support said walls, said tubular body extending around said axis and being provided with: two through grooves parallel to said axis; and two faces separated by said grooves and converging towards said axis.

The tubular body basically defines the bearing structure of the clamping tool and gives sturdiness and shape stability to the clamping tool, which has to perform a large number of processing cycles. In particular, the tubular body is made of aluminum or of an aluminum alloy. In particular, said walls adhere to the said faces, which basically define the shape of the walls in rest conditions.

From a constructive point of view, the tubular body is coated, along the inner surface, with a tubular membrane of deformable material, in particular rubber, which follows the shape of said inner surface and, at the same time, defines said walls. In particular, the tubular membrane is caused to be integral to the tubular body in the area of the first and of the second opening, so as to create a firm and fluid-tight connection.

According to an embodiment, the tubular body comprises a through hole in the area of each face for feeding a compressible fluid between each face and the respective wall. In this way, the walls can be inflated and adjusted to the shape and the size of the fruit and, at the same time, the pressure exerted upon the fruit can be controlled. The absence of a chamber between the walls and the tubular body allows the walls to be quickly inflated with the desired pressure.

According to the invention, the clamping tool comprises a ring attached to the tubular body, which has anchor elements for attaching support elements configured to move the clamping tool between a rest position and an operating position around a fruit. In particular, the ring is made of a more resilient material than aluminum and, hence, avoids possible critical issues in particularly stressed areas such as the ones involving a connection to the support elements for the movements of the clamping tool. The ring comprises two notches partly defining the channels so as to at least partly accommodate the blades.

According to an alternative embodiment of the invention, the clamping tool comprises anchor elements embedded in the tubular body for securing support elements configured to move the clamping tool between a rest position and an operating position around a fruit. In particular, in this embodiment, the tubular body is made of a polymer material, which makes the clamping tool particularly light.

The invention further relates to a pitting machine capable of overcoming the drawbacks of the prior art.

According to the invention, there is provided a machine for pitting fruits, in particular peaches, the machine comprising: a clamping tool as identified above and configured to be arranged above and around a fruit through a first opening of the clamping tool; a device for inflating the walls arranged within the clamping tool in order to clamp the fruit in a given position;
two blades configured to be inserted into the clamping tool through the second opening of the clamping tool in a first direction; actuators for moving the blades in a second and third direction, respectively, until the blades are partly housed in the two respective channels; and a pitting knife configured to be inserted into the clamping tool into a slot in the fruit formed by the blades and between the two blades. In this way, cutting and stone separation operations can be carried out in one single station and the pitting knife can be inserted into the fruit without damaging the pulp.

The invention is also aimed at providing a method capable of overcoming the drawbacks of the prior art.

According to the invention, there is provided a pitting method for pitting fruits, in particular peaches, the method comprising: arranging a clamping tool above and around a fruit through a first opening of the clamping tool; inflating walls arranged inside the clamping tool in order to clamp the fruit in a given position; inserting two blades inside the clamping tool through a second opening of the clamping tool in a first direction; moving the blades in a second and third direction, respectively, until the blades are at least partly housed in two respective channels separating said walls; and inserting a pitting knife into the clamping tool and between the two blades into a slot in the fruit formed by the blades.

Thanks to this method, the fruit can be held in a given position, the cut as well as the stone separation can be performed in the same processing station and without releasing the fruit, the pitting knife can be inserted into a slot, which remains spread thanks to the blades. This last aspect allows the pitting knife to be inserted without scratching the previously cut faces of the fruit. The absence of signs and incisions in the cut fruit is a parameter to be considered when assessing the quality of the finished product, namely the cut fruit without stone.

According to the invention, the method further entails: rotating the pitting knife around the axis; extracting the pitting knife from the fruit through the slot formed in the fruit. Even during the extraction of the pitting knife, the cut faces are preserved from possible incisions or notches, which could jeopardize the quality thereof.

### BRIEF DESCRIPTION OF THE DRAWINGS

Further features and advantages of the invention will be best understood upon perusal of the following description of non-limiting embodiments thereof, with reference to the accompanying drawing, wherein:

FIG. 1 is a perspective view, with parts removed for greater clarity, of a fruit clamping tool;

FIG. 2 is an exploded perspective view, with parts removed for greater clarity, of the clamping tool of FIG. 1;

FIGS. 3 to 6 are elevation views, with sectional parts and with parts removed for greater clarity, of a pitting machine comprising the clamping tool of FIG. 1 in a sequence of operating steps;

FIG. 7 is a sectional perspective view, with parts removed for greater clarity, of an alternative embodiment of the invention.

### DESCRIPTION OF EMBODIMENTS

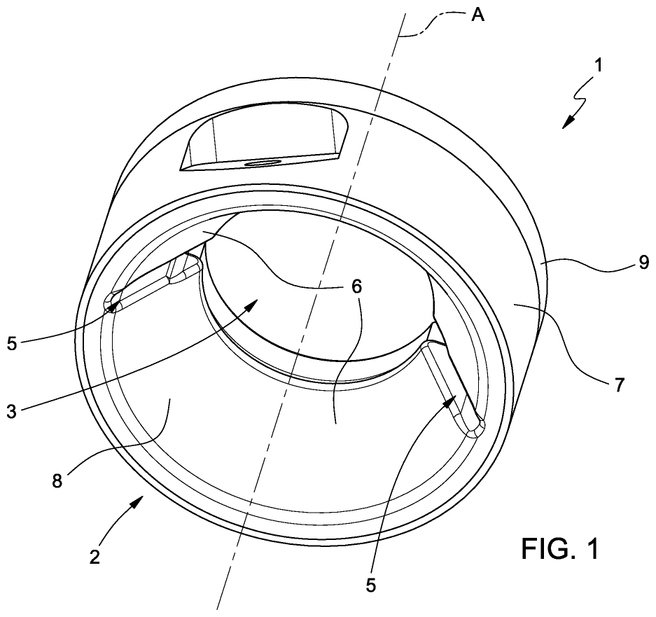

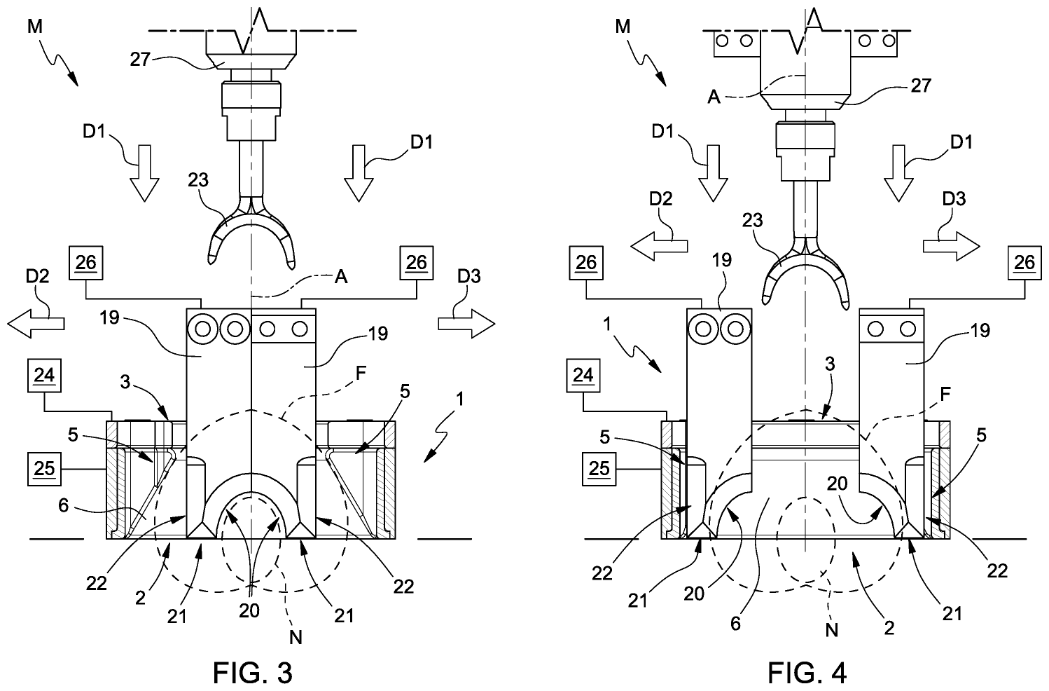

In FIG. 1, number 1 indicates a clamping tool for clamping a fruit, in particular a peach, in a given position in a processing station of a pitting machine. The clamping tool 1 has a tubular shape, extends around and along an axis A, is mounted in a pitting machine M, FIGS. 3-6, and has an opening 2 configured to allow the clamping tool 1 to be arranged over and around the fruit F (FIGS. 3-6); an opening 3, which is smaller than the opening 2 and is arranged on the opposite side relative to the opening 2, to allow cutting tools to be inserted into the clamping tool 1 in a direction parallel to the axis A; two channels 5 substantially parallel to the axis A extending inside the clamping tool 1 from the opening 2 to the opening 3; and two walls 6 extending inside the clamping tool 1 between the openings 2 and 3, facing one another, separated by the channels 5 and converging towards the axis A. The walls 6 are made of a deformable material, preferably rubber.

Form a constructive point of view, the clamping tool 1 comprises a tubular body 7 preferably made of aluminum or of an aluminum alloy and configured to support the walls 6; a tubular membrane 8 of deformable material; and a ring 9 preferably made of steel.

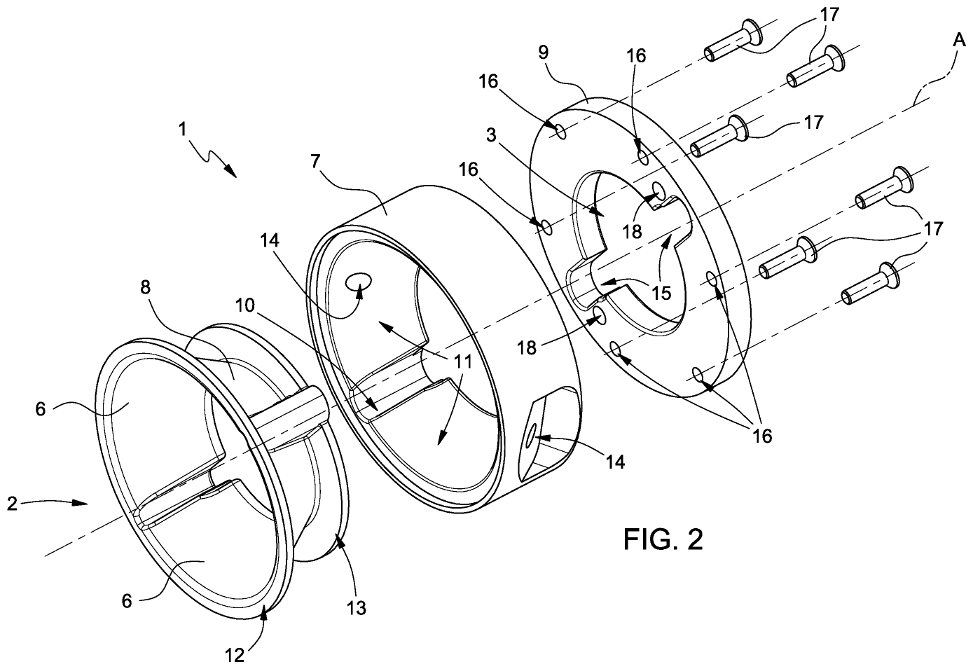

With reference to FIG. 2, the tubular body 7 extends around and along the axis A and has an inner surface defined by two through grooves 10 (only one of them being visible in FIG. 2) parallel to the axis A and by two faces 11, which are separated by the grooves 10 and converge from the opening 2 to the opening 3 towards the axis A. The grooves 10 are diametrically opposite one another relative to the axis A.

The tubular membrane 8 of deformable material, in particular rubber, is shaped so as to follow the shape of the inner surface of the tubular body 7 and has two end flanges 12, 13. The tubular membrane 8 covers the entire inner surface of the tubular body 7 and is fixed, through gluing or vulcanization, to the tubular body 7 in the area of the flanges 12 and 13 and of the grooves 10. In particular, the tubular membrane 8 forms, in the area of the faces 11, the deformable walls 6, which adhere to the faces 11, but are capable of deforming and detaching themselves from the faces 11 when a fluid under pressure is fed between the walls 6 and the tubular body 7.

The tubular body 7 comprises two holes 14 in the area of the faces 11 in order to feed a fluid under pressure, typically air, aimed at deforming the walls 6 detaching them from the faces 11.

The ring 9 has a supporting function and has two notches 15 arranged in the area of the grooves 10, a series of threaded holes 16 to fix the ring 9 to the tubular body 7 by means of screws 17 and two threaded holes 18 to suspend the clamping tool 1 to support arms that are not shown in the accompanying Figures. The notches 15 are diametrically opposite relative to the axis, are aligned with the grooves 10 and define part of the channels 5.

With reference to FIG. 3, M indicates a pitting machine comprising a clamping tool 1, two blades 19, each provided with three cutting edges 20, 21 and 22, and a pitting knife 23 shaped like a fork.

The machine M further comprises an operating device 24 to lower the clamping tool 1 in the direction D1 and lift it in the direction contrary to D1; a feeding device 25 to selectively feed the fluid under pressure to the clamping tool 1 and to inflate the walls 6; two operating devices 26 to operate the respective blades 19 in the direction D1, D2 and D3; and an operating device 27 to lower the pitting knife 23 in the direction D1 and lift it in the direction contrary to D1 and to rotate the pitting knife 23 around the axis A.

In use, the clamping tool 1 is placed over a fruit F arranged in a cradle, not shown, so as to clamp the fruit F between the cradle, not shown, and the clamping tool 1. The walls 6 are subsequently inflated so that they adhere, to a large extent, to the outer face of the fruit F.

Then, the two blades 19, which are symmetrically arranged and are next to one another, are inserted: the two cutting edges 20 are adjacent to one another so as to form an arch arranged over and around the stone N of the fruit N. Each cutting edge 21 is adjacent to the respective cutting edge 20 and perpendicular to the axis A, whereas the cutting edge 21 is adjacent to the respective cutting edge 20 and parallel to the axis A.

The cutting edges 20 and 21 cut into the fruit F during the insertion of the blades 19 into the clamping tool 1, whereas the cutting edges 22 further cut into the fruit F during the movement of the blades in the respective directions D2 and D3 until a position is reached, in which the blades 19 are at least partly accommodated in the respective channels 5 of the clamping tool 1, as shown in FIG. 4.

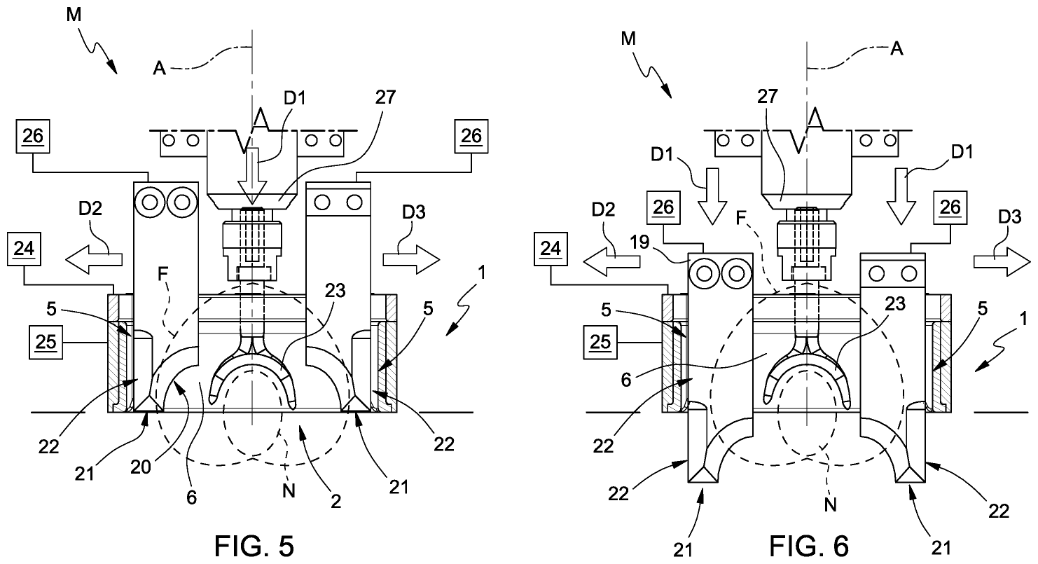

With reference to FIG. 5, once the blades 19 have been moved away from one another in the opposite directions D2 and D3, the pitting knife 23 is inserted into the clamping tool 1 and into the fruit F, while the blades 19 maintain the parts of the fruit spread apart, where they made a slit that helps the pitting knife 23 be inserted. Once inserted, the pitting knife 23 is rotated around the axis A so as to isolate the stone N from the pulp at least in the upper part of the fruit F.

With reference to FIG. 6, the blades 19 are further moved in the direction D1 in order to complete the cut of the fruit F before extracting, one after the other, the pitting knife 23 and the blades 19, releasing the fluid in the clamping tool 1 and lifting the clamping tool 1.

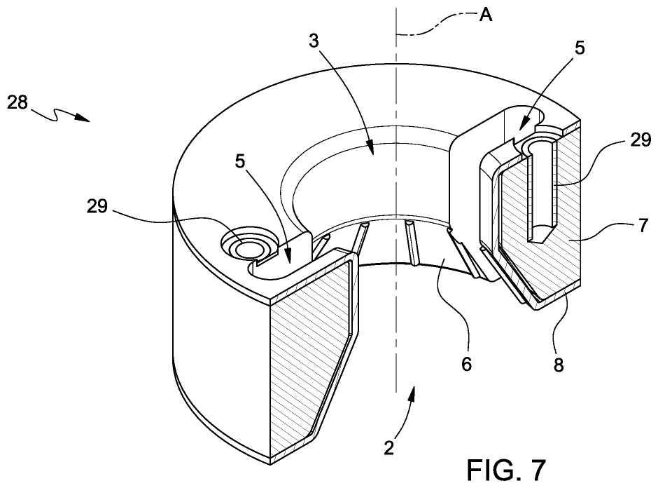

With reference to the variant of FIG. 7, reference number 28 indicates a clamping tool in which the clamping ring is absent and the tubular body 7 has two openings in which two threaded bushings 29 are embedded in order to fix support arms that are not shown in the accompanying Figures.

This description is clearly limited to the operations carried out for the upper part of the fruit, but the operations concerning the lower part of the fruit obviously are substantially similar, except for the fact the fruit is supported by cradle of a conveyor belt.

Finally, the subject-matter of the invention described herein can clearly be subjected to changes and variations, without for this reason going beyond the scope of protection of the appended claims.

1. A clamping tool for clamping a fruit, in particular peaches, in a given position in a processing station of a pitting machine, the clamping tool having a tubular shape and extending about a given axis and being provided with:
a first opening configured to allow the clamping tool to be arranged over and around the fruit;
a second opening smaller than the first opening and arranged on the opposite side of the first opening to allow the insertion of cutting tools inside the clamping tool in a direction parallel to said axis;
two through channels substantially parallel to said axis extending from the first openings to the second opening; and
two walls facing each other and separated by said channels and converging towards said axis between said first and second openings.

2. The clamping tool as claimed in claim 1, wherein said walls are made of deformable material, in particular rubber.

3. The clamping tool as claimed in claim 1, and comprising a tubular body configured to support said walls, said tubular body extending about said axis and being provided with:
two through grooves parallel to said axis; and
two faces separated by said grooves and converging towards said axis.

4. The clamping tool as claimed in claim 3, wherein said walls adhere to said faces.

5. The clamping tool as claimed in claim 3, wherein said tubular body is coated along its inner surface with a tubular membrane of deformable material, in particular rubber, which follows the shape of said inner surface.

6. The clamping tool claimed in claim 5, wherein the tubular membrane is made integral with the tubular body at the first and second openings.

7. The clamping tool as claimed in claim 3, wherein the tubular body comprises a through hole at each face for feeding a compressible fluid between each face and the respective wall.

8. The clamping tool as claimed in claim 3, and comprising a ring attached to the tubular body and comprising anchor elements for attaching support elements configured to move the clamping tool between a resting position and an operating position around a fruit.

9. The clamping tool as claimed in claim 8, wherein the ring comprises two notches partially defining said channels.

10. The clamping tool as claimed in claim 3, and comprising anchor elements embedded in the tubular body for securing support elements configured to move the clamping tool between a rest position and an operating position around a fruit.

11. A machine for pitting fruits, in particular peaches, the machine comprising:
a clamping tool as claimed in claim 1 and configured to be arranged above and around a fruit through a first opening of the clamping tool;
a device for inflating the walls arranged within the clamping tool to clamp the fruit in a given position;
two blades configured to be inserted inside the clamping tool through the second opening of the clamping tool in a first direction;
actuators for moving the blades in a second and third direction respectively until the blades are partially housed in the two respective channels; and
a pitting knife configured to be inserted into the clamping tool into a slot in the fruit formed by the blades.

12. A method of pitting fruits, in particular peaches, the method comprising:
arranging a clamping tool as claimed in claim 1 above and around a fruit through a first opening of the clamping tool;
inflating the walls arranged inside the clamping tool to clamp the fruit in a given position;
inserting two blades inside the clamping tool through a second opening of the clamping tool in a first direction;
moving the blades respectively in a second and third direction until the blades are partially housed in the two respective channels; and
inserting a pitting knife in the clamping tool into a slot in the fruit formed by the blades.

13. The method as claimed in claim 12, and comprising:
rotating the pitting knife about the axis;
extracting the pitting knife from the fruit through the slot formed in the fruit.
